(19) United States
(12) Patent Application Publication
(10) Pub. No.: US 2011/0026606 A1
(43) Pub. Date: Feb. 3, 2011

(54) SYSTEM AND METHOD FOR ENHANCING THE VISIBILITY OF AN OBJECT IN A DIGITAL PICTURE

(75) Inventors: Sitaram Bhagavathy, Plainsboro, NJ (US); Joan Llach, Princeton, NJ (US); Yu Huang, Bridgewater, NJ (US)

Correspondence Address: Robert D. Shedd, Patent Operations;THOMSON Licensing LLC, P.O. Box 5312, Princeton, NJ, 08543-5312, US

(73) Assignee: Thomson Licensing

(21) Appl. No.: 12/736,408

(22) PCT Filed: Apr. 7, 2009
(86) PCT No.: PCT/US09/02173

§ 371 Date: Oct. 6, 2010

Related U.S. Application Data
(60) Provisional application No. 60/123,844, filed on Mar. 11, 1999.

(51) Int. Cl. H04N 7/12

(52) U.S. Cl. 375/240.26; 375/E07.076; 375/E07.027

(57) ABSTRACT

The visibility of an object in a digital picture is enhanced by comparing an input video of the digital picture with stored information representative of the nature and characteristics of the object to develop object localization information that identifies and locates the object. The visibility of the object and the region in which the object is located is enhanced by image processing and the enhanced input video is encoded.

### CROSS-REFERENCE TO RELATED APPLICATIONS

This application claims the benefit of U.S. Provisional Patent Application Ser. No. 61/123,844 (Atty Docket PU080054), entitled “PROCESSING IMAGES HAVING OBJECTS” and filed Apr. 11, 2008, which is incorporated by reference herein in its entirety.

### FIELD OF THE INVENTION

The present invention relates, in general, to the transmission of digital pictures and, in particular, to enhancing the visibility of objects of interest in digital pictures, especially digital pictures that are displayed in units that have low resolution, low bit rate video coding.

### BACKGROUND OF THE INVENTION

There is an increasing demand for delivering video content to handheld devices, such as cell phones and PDA's. Because of small screen sizes, limited bandwidth and limited decoder-end processing power, the videos are encoded with low bit rates and at low resolutions. One of the main problems of low resolution, low bit rate video encoding is the degradation or loss of objects crucial to the perceived video quality. For example, it is annoying to watch a video clip of a soccer match or a tennis match when the ball is not clearly visible.

### SUMMARY OF THE INVENTION

It is, therefore, desirable to highlight objects of interest to improve the subjective visual quality of low resolution, low bit rate video. In various implementations of the present invention, the visibility of an object of interest in a digital image is enhanced, given the approximate location and size of the object in the image, or the visibility of the object is enhanced after refinement of the approximate location and size of the object. Object enhancement provides at least two benefits. First, object enhancement makes the object easier to see and follow, thereby improving the user experience. Second, object enhancement helps the object sustain less degradation during the encoding (i.e., compression) stage. One main application of the present invention is video delivery to handheld devices, such as cell phones and PDA's, but the features, concepts, and implementations of the present invention also may be useful for a variety of other applications, contexts, and environments, including, for example, video over internet protocol (low bit rate, standard definition content).

The present invention provides for highlighting objects of interest in video to improve the subjective visual quality of low resolution, low bit rate video. The inventive system and method are able to handle objects of different characteristics and operate in fully-automatic, semi-automatic (i.e., manually assisted), and full manual modes. Enhancement of objects can be performed at a pre-processing stage (i.e., before or in the video encoding stage) or at a post-processing stage (i.e., after the video decoding stage).

In accordance with the present invention, the visibility of an object in a digital picture is enhanced by providing an input video containing an object, storing information representative of the nature and characteristics of the object, and developing, in response to the video input and the information representative of the nature and characteristics of the object, object localization information that identifies and locates the object. An enhanced video of that portion of the input video that contains the object and the region in which the object is located is developed from the input video in response to the object localization information and the enhanced video is encoded.

### BRIEF DESCRIPTION OF THE DRAWINGS

FIG. 1 is a block diagram of a preferred embodiment of a system for enhancing the visibility of an object in a digital video constructed in accordance with the present invention.

FIG. 2 illustrates approximate object localization provided by the FIG. 1 system.

FIGS. 3A through 3D illustrate the work-flow in object enhancement in accordance with the present invention.

FIG. 4 is a flowchart for an object boundary estimation algorithm that can be used to refine object identification information and object location information in accordance with the present invention.

FIGS. 5A through 5D illustrate the implementation of the concept of level set estimation of boundaries of arbitrarily shaped objects in accordance with the present invention.

FIG. 6 is a flowchart for an object enlargement algorithm in accordance with the present invention.

FIGS. 7A through 7C illustrate three possible sub-divisions of a 16×16 macroblock useful in explaining the refinement of object identification information and object location information during the encoding stage.

### DETAILED DESCRIPTION OF THE INVENTION

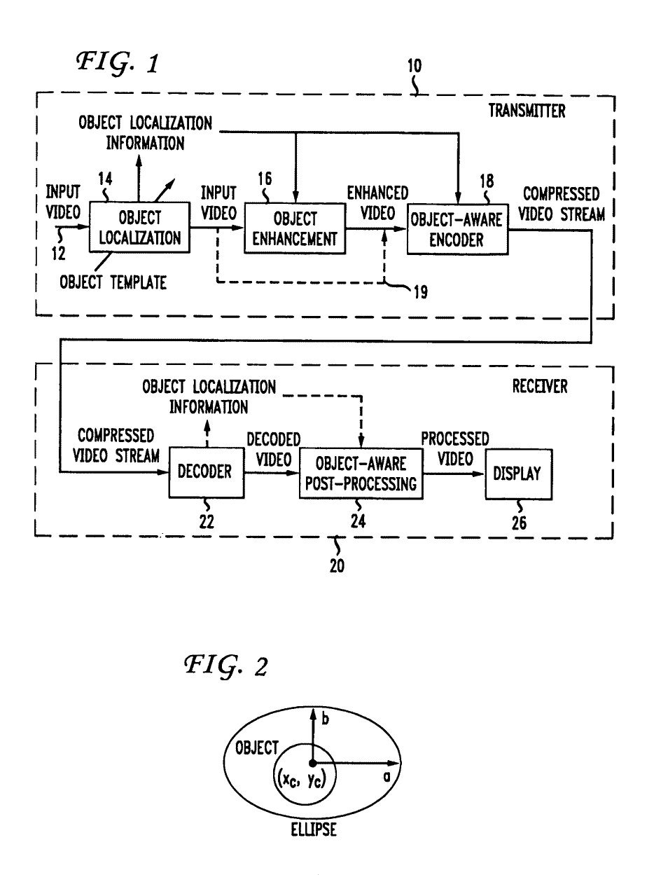

Referring to FIG. 1, an object enhancing system, constructed in accordance with the present invention, may span all the components in a transmitter 10, or the object enhancement component may be in a receiver 20. There are three stages in the process chain where object highlighting may be performed: (1) pre-processing where the object is enhanced in transmitter 10 prior to the encoding (i.e., compression) stage; (2) encoding where the region of interest that contains the object is given special treatment in transmitter 10 by the refinement of information about the object and its location; and (3) post-processing where the object is enhanced in receiver 20 after decoding utilizing side-information about the object and its location transmitted from transmitter 10 through the bitstream as metadata. An object enhancing system, constructed in accordance with the present invention, can be arranged to provide object highlighting in only one of the stages identified above, or in two of the stages identified above, or in all three stages identified above.

The FIG. 1 system for enhancing the visibility of an object in a digital picture includes means for providing an input video containing an object of interest. The source of the digital picture that contains the object, the visibility of which is to be enhanced, can be a television camera of conventional construction and operation and is represented by an arrow 12.

The FIG. 1 system also includes means for storing information representative of the nature and characteristics of the object of interest (e.g., an object template) and developing, in response to the video input and the information representative of the nature and characteristics of the object, object localization information that identifies and locates the object. Such means, identified in FIG. 1 as an object localization module 14, include means for scanning the input video, on a frame-by-frame basis, to identify the object (i.e., what is the object) and locate that object (i.e., where is the object) in the picture having the nature and characteristics similar to the stored information representative of the nature and characteristics of the object of interest. Object localization module 14 can be a unit of conventional construction and operation that scans the digital picture of the input video on a frame-by-frame basis and compares sectors of the digital picture of the input video that are scanned with the stored information representative of the nature and characteristics of the object of interest to identify and locate, by grid coordinates of the digital picture, the object of interest when the information developed from the scan of a particular sector is similar to the stored information representative of the nature and characteristics of the object.

In general, object localization module 14 implements one or more of the following methods in identifying and locating an object of interest:
Object tracking—The goal of an object tracker is to locate a moving object in a video. Typically, a tracker estimates the object parameters (e.g. location, size) in the current frame, given the history of the moving object from the previous frames. Tracking approaches may be based on, for example, template matching, optical flow, Kalman filters, mean shift analysis, hidden Markov models, and particle filters.
Object detection—The goal in object detection is to detect the presence and location of an object in images or video frames based on prior knowledge about the object. Object detection methods generally employ a combination of top-down and bottom-up approaches. In the top-down approach, object detection methods are based on rules derived from human knowledge of the objects being detected. In the bottom-up approach, object detection methods associate objects with low-level structural features or patterns and then locate objects by searching for these features or patterns.
Object segmentation—In this approach, an image or video is decomposed into its constituent “objects,” which may include semantic entities or visual structures, such as color patches. This decomposition is commonly based on the motion, color, and texture attributes of the objects. Object segmentation has several applications, including compact video coding, automatic and semi-automatic content-based description, film post-production, and scene interpretation. In particular, segmentation simplifies the object localization problem by providing an object-based description of a scene.

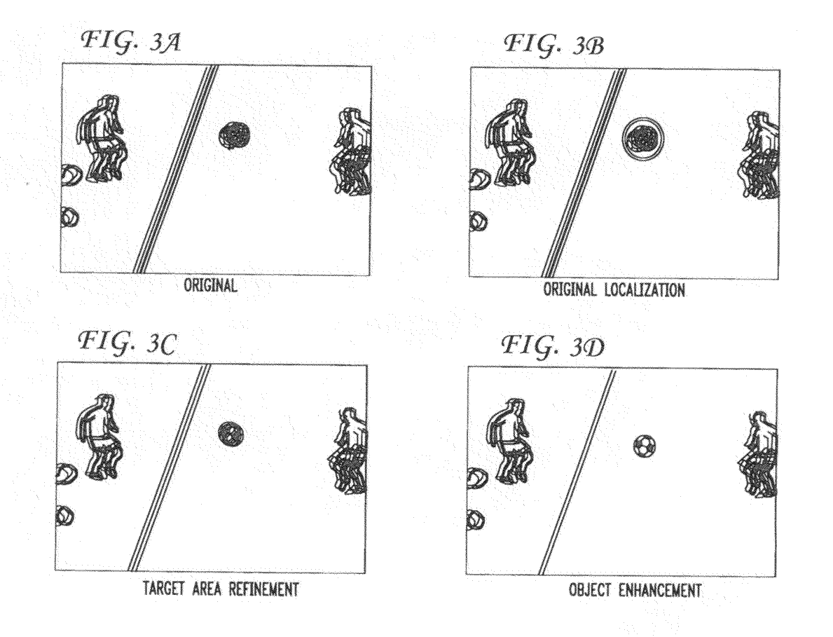

FIG. 2 illustrates approximate object localization provided by object localization module 14. A user draws, for example, an ellipse around the region in which the object is located to approximately locate the object. Eventually, the approximate object localization information (i.e., the center point, major axis, and minor axis parameters of the ellipse) is refined.

Ideally, object localization module 14 operates in a fully automated mode. In practice, however, some manual assistance might be required to correct errors made by the system, or, at the very least, to define important objects for the system to localize. Enhancing non-object areas can cause the viewer to be distracted and miss the real action. To avoid or minimize this problem, a user can draw, as described above, an ellipse around the object and the system then can track the object from the specified location. If an object is successfully located in a frame, object localization module 14 outputs the corresponding ellipse parameters (i.e., center point, major axis, and minor axis). Ideally, the contour of this bounding ellipse would coincide with that of the object.

When, however, the parameters might be only approximate and the resulting ellipse does not tightly contain the object and object enhancement is applied, two problems might occur. First, the object might not be wholly enhanced because the ellipse does not include the entire object. Second, non-object areas might be enhanced. Because both these results can be undesirable, it is useful, under such circumstances, to refine the object region before enhancement. Refinement of object localization information is considered in greater detail below.

The FIG. 1 system further includes means, responsive to the video input and the object localization information that is received from object localization module 14 for developing an enhanced video of that portion of the digital picture that contains the object of interest and the region in which the object is located. Such means, identified in FIG. 1 as an object enhancement module 16, can be a unit of conventional construction and operation that enhances the visibility of the region of the digital picture that contains the object of interest by applying conventional image processing operations to this region. The object localization information that is received, on a frame-by-frame basis, from object localization module 14 includes the grid coordinates of a region of predetermined size in which the object of interest is located. In addition, as indicated above, object enhancement helps in reducing degradation of the object during the encoding stage which follows the enhancement stage and is described below. The operation of the FIG. 1 system up to this point corresponds to the pre-processing mode of operation referred to above.

When enhancing the object, the visibility of the object is improved by applying image processing operations in the region in which the object of interest is located. These operations can be applied along the object boundary (e.g. edge sharpening), inside the object (e.g. texture enhancement), and possibly even outside the object (e.g. contrast increase, blurring outside the object area). For example, one way to draw more attention to an object is to sharpen the edges inside the object and along the object contour. This makes the details in the object more visible and also makes the object stand out from the background. Furthermore, sharper edges tend to survive encoding better. Another possibility is to enlarge the object, for instance by iteratively applying smoothing, sharpening and object refinement operations, not necessarily in that order.

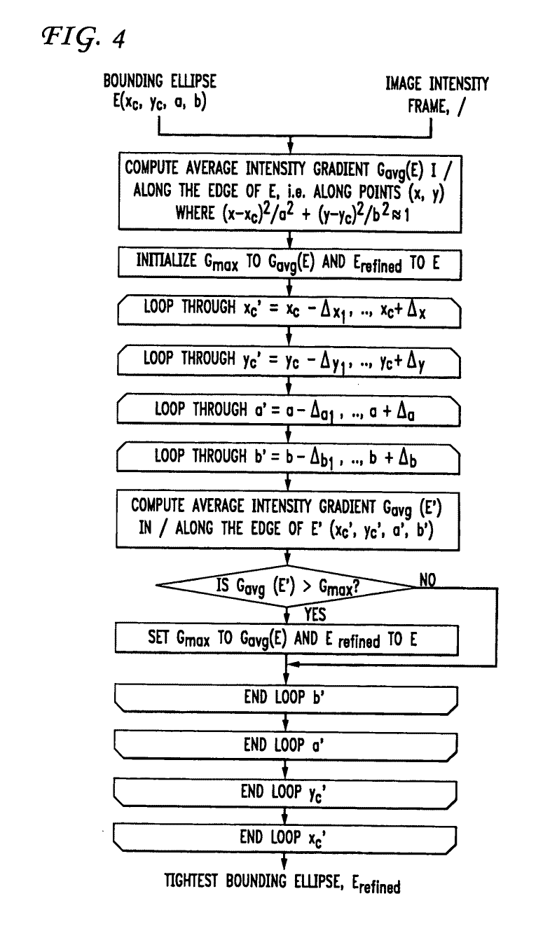

FIGS. 3A through 3D illustrate the work-flow in the object enhancement process. FIG. 3A is a single frame in a soccer video with the object in focus being a soccer ball. FIG. 3B shows the output of object localization module 14, namely the object localization information of the soccer ball in the frame. FIG. 3C illustrates a region refinement step, considered in greater detail below, wherein the approximate object location information of FIG. 3B is refined to develop a more accurate estimate of the object boundary, namely the light colored line enclosing the ball. FIG. 3D shows the result after applying object enhancement, in this example the edge sharpening. Note that the soccer ball is sharper in FIG. 3D, and thus more visible, than in the original frame of FIG. 3A. The object also has higher contrast, which generally refers to making the dark colors darker and the light colors lighter.

Inclusion of object enhancement in the FIG. 1 system provides significant advantages. Problems associated with imperfect tracking and distorted enhancements are overcome. Imperfect tracking might make it difficult to locate an object. From frame-to-frame, the object location may be slightly off and each frame may be slightly off in a different manner. This can result in flickering due to, for example, pieces of the background being enhanced in various frames, and/or different portions of the object being enhanced in various frames. Additionally, common enhancement techniques can, under certain circumstances, introduce distortions.

As indicated above, refinement of the object localization information, prior to enhancement, might be required when the object localization information only approximates the nature of the object and the location of the object in each frame to avoid enhancing features outside the boundary of the region in which the object is located.

The development of the object localization information by object localization module 14 and the delivery of the object localization information to object enhancement module 16 can be fully-automatic as described above. As frames of the input video are received by object localization module 14, the object localization information is updated by the object localization module and the updated object localization information is delivered to object enhancement module 16.

The development of the object localization information by object localization module 14 and the delivery of the object localization information to object enhancement module 16 also can be semi-automatic. Instead of delivery of the object localization information directly from object localization module 14 to object enhancement module 16, a user, after having available the object localization information, can manually add to the digital picture of the input video markings, such boundary lines, which define the region of predetermined size in which the object is located.

The development of the object localization information and delivery of the object localization information to object enhancement module 16 also can be fully-manual. In such operation, a user views the digital picture of the input video and manually adds to the digital picture of the input video markings, such boundary lines, which define the region of predetermined size in which the object is located. As a practical matter, fully-manual operation is not recommended for live events coverage.

The refinement of object localization information, when necessary or desired, involves object boundary estimation, wherein the exact boundary of the object is estimated. The estimation of exact boundaries helps in enhancing the object visibility without the side effect of unnatural object appearance and motion and is based on several criteria. Three approaches for object boundary estimation are disclosed.

The first is an ellipse-based approach that determines or identifies the ellipse that most tightly bounds the object by searching over a range of ellipse parameters. The second approach for object boundary estimation is a level-set based search wherein a level-set representation of the object neighborhood is obtained and then a search is conducted for the level-set contour that most likely represents the object boundary. A third approach for object boundary estimation involves curve evolution methods, such as contours or snakes, that can be used to shrink or expand a curve with certain constraints, so that it converges to the object boundary. Only the first and second approaches for object boundary estimation are considered in greater detail below.

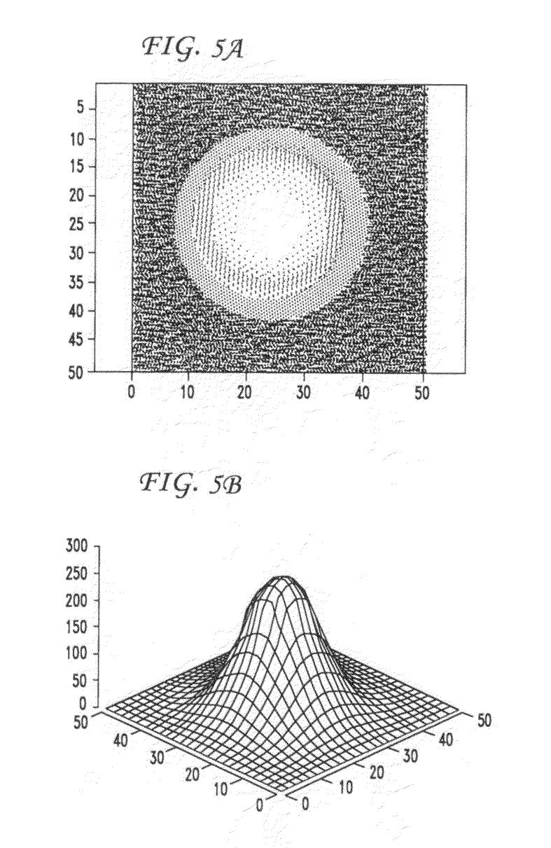

In the ellipse-based approach, object boundary estimation is equivalent to determining the parameters of the ellipse that most tightly bounds the object. This approach searches over a range of ellipse parameters around the initial values (i.e., the output of the object localization module 14) and determines the tightness with which each ellipse bounds the object. The output of the algorithm, illustrated in FIG. 4, is the tightest bounding ellipse.

The tightness measure of an ellipse is defined to be the average gradient of image intensity along the edge of the ellipse. The rationale behind this measure is that the tightest bounding ellipse should follow the object contour closely and the gradient of image intensity is typically high along the object contour (i.e., the edge between object and background). The flowchart for the object boundary estimation algorithm is shown in FIG. 4. The search ranges (Δₓ, Δ_{y}, Δₐ, Δ_{b}) for refining the parameters are user-specified.

The flow chart of FIG. 4 begins by computing the average intensity gradient. Then variables are initialized and four nested loops for horizontal centerpoint location, vertical centerpoint location, and the two axes are entered. If the ellipse described by this centerpoint and the two axes produces a better (i.e., larger) average intensity gradient, then this gradient value and this ellipse are noted as being the best so far. Next is looping through all four loops, exiting with the best ellipse.

The ellipse-based approach may be applied to environments in which the boundary between the object and the background has a uniformly high gradient. However, this approach may also be applied to environments in which the boundary does not have a uniformly high gradient. For example, this approach is also useful even if the object and/or the background has variations in intensity along the object/background boundary.

The ellipse-based approach produces, in a typical implementation, the description of a best-fit ellipse. The description typically includes centerpoint, and major and minor axes.

An ellipse-based representation can be inadequate for describing objects with arbitrary shapes. Even elliptical objects may appear to be of irregular shape when motion-blurred or partially occluded. The level-set representation facilitates the estimation of boundaries of arbitrarily shaped objects.

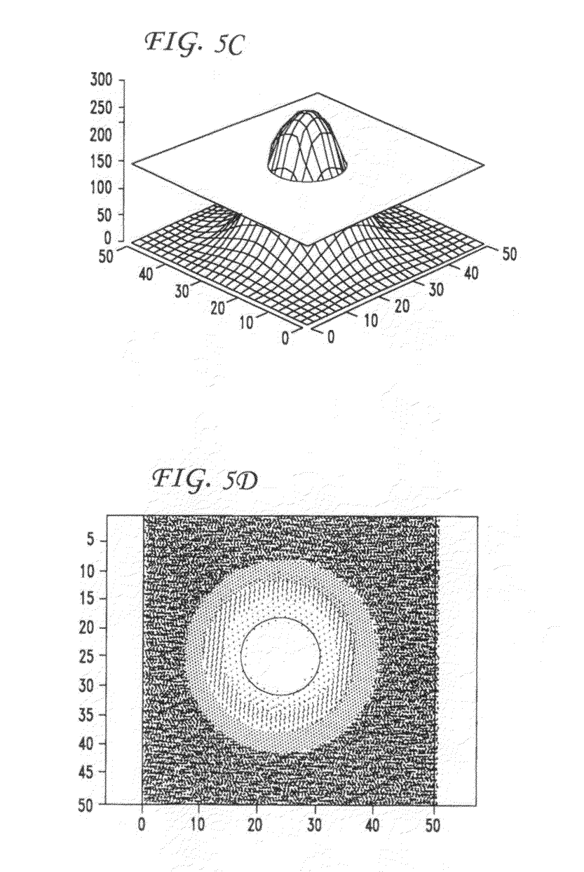

FIGS. 5A through 5D illustrate the concept of the level-set approach for object boundary estimation. Suppose that the intensity image I(x, y) is a continuous intensity surface, such as shown in FIG. 5B, and not a grid of discrete intensities, such as shown in FIG. 5A. The level set at an intensity value i, is the set of closed contours defined by Iₗ(i)={(x, y)|I(x, y)=i}. The closed contours may be described as continuous curves or by a string of discrete pixels that follow the curve. A level-set representation of image I is a set of level-sets at different intensity level values, (i.e., Lₗ(M)={Iₗ(i)|iεM}). For example, M={0, . . . , 255} or M={50.5, 100.5, 200.5}. Level-sets can be extracted from images by several methods. One of these methods is to apply bilinear interpolation between sets of four pixels at a time in order to convert a discrete intensity grid into an intensity surface, continuous in both space and intensity value. Thereafter, level-sets, such as shown in FIG. 5D, are extracted by computing the intersection of the surface with one or more level planes, such as shown in FIG. 5C, (i.e., horizontal planes at specified levels).

A level-set representation is analogous in many ways to a topographical map. The topographical map typically includes closed contours for various values of elevation.

In practice, the image I can be a subimage containing the object whose boundary is to be estimated. A level-set representation, Lₗ(M), where M={i₁, i₂ . . . , i_{N}} is extracted. The set M can be constructed based on the probable intensities of the object pixels, or could simply span the entire intensity range with a fixed step, (e.g. M={0.5, 1.5, . . . , 254.5, 255.5}). Then, all the level-set curves (i.e., closed contours) Cⱼ; contained in the set Lₗ(M) are considered. Object boundary estimation is cast as a problem of determining the level-set curve, C*, which best satisfies a number of criteria relevant to the object. These criteria may include, among others, the following variables:
average intensity gradient along Cⱼ;
the area inside Cⱼ;
the length of Cⱼ;
the location of the center of Cⱼ.
the mean and/or variance of the intensities of pixels contained by Cⱼ;

The criteria may place constraints on these variables based on prior knowledge about the object. In the following, there is described a specific implementation of object boundary estimation using level-sets.

Let m_{ref}, s_{ref}, a_{ref}, and x_{ref}=(x_{ref}, y_{ref}), be the reference values for the mean intensity, standard deviation of intensities, area, and the center, respectively, of the object. These can be initialized based on prior knowledge about the object, (e.g., object parameters from the object localization module 14, for example, obtained from an ellipse). The set of levels, M, is then constructed as,

M={iₘᵢₙ,iₘᵢₙ+Δₗ,iₘᵢₙ+2Δₗ, . . . ,iₘₐₓ},

where iₘᵢₙ=└m_{ref}−s_{ref}┘−0.5, iₘₐₓ=└m_{ref}+s_{ref}┘+0.5, and Δₗ=└(iₘₐₓ−iₘᵢₙ)/N┘, where N is a preset value (e.g., 10). Note that └.┘ denotes an integer flooring operation.

For a particular level-set curve Cⱼ, let mⱼ, sⱼ, aⱼ, and xⱼ=(xⱼ, yⱼ), be the measured values of the mean intensity, standard deviation of intensities, area, and the center, respectively, of the image region contained by Cⱼ. Also computed are the average intensity gradients, G_{avg}(Cⱼ), along Cⱼ. In other words, G_{avg}(Cⱼ) is the average of the gradient magnitudes at each pixel on Cⱼ. For each Cⱼ, a score is now computed as follows:

S(Cⱼ)=G_{avg}(Cⱼ)Sₐ(a_{ref},aⱼ)Sₓ(x_{ref},xⱼ)

where Sₐ and Sₓ are similarity functions whose output values lie in the range [0, 1], with a higher value indicating a better match between the reference and measured values. For example, Sₐ=exp(−|a_{ref}−aⱼ|) and Sₓ=exp(−∥x_{ref}−xⱼ∥₂). The object boundary C* is then estimated as the curve that maximizes this score,

$$( i . e . , {C}^{*} = {arg max}_{{C}_{j}} [ S ( {C}_{j} ) ] ) .$$

After estimating the object boundary, the reference values m_{ref}, s_{ref}, a_{ref}, and x_{ref} can be updated with a learning factor αε[0, 1],

(e.g., m_{ref}^{new}=αmⱼ+(1−α)m_{ref}). In the case of a video sequence, the factor αcould be a function of time (e.g., frame index) t, starting at a high value and then decreasing with each frame, finally saturating to a fixed low value, αₘᵢₙ.

In the enhancement of the object, the visibility of the object is improved by applying image processing operations in the neighborhood of the object. These operations may be applied along the object boundary (e.g., edge sharpening), inside the object (e.g., texture enhancement), and possibly even outside the object (e.g., contrast increase). In implementations described herein, a number of methods for object enhancement are proposed. A first is to sharpen the edges inside the object and along its contour. A second is to enlarge the object by iteratively applying smoothing, sharpening and boundary estimation operations, not necessarily in that order. Other possible methods include the use of morphological filters and object replacement.

One way to draw more attention to an object is to sharpen the edges inside the object and along the contour of the object. This makes the details in the object more visible and also makes the object stand out from the background. Furthermore, sharper edges tend to survive compression better. The algorithm for object enhancement by sharpening operates on an object one frame at a time and takes as its input the intensity image I(x, y), and the object parameters (i.e., location, size, etc.) provided by object localization module 14. The algorithm comprises three steps as follows:
Estimate the boundary of the object, O.
Apply the sharpening filter F_{α} to all the pixels in image I, inside and on the object boundary. This gives new sharpened values, Iₛₕₐᵣₚ(x, y) for all pixels contained by O,
where Iₛₕₐᵣₚ(x, y)=(I*F_{α})(x, y), and (I*F_{α}) indicates the convolution of image I with the sharpening filter F_{α}.
Replace pixels I(x, y) with Iₛₕₐᵣₚ(x, y) for all (x, y) inside or on O.

The sharpening filter F_{α} is defined as the difference of the Kronecker delta function and the discrete Laplacian operator ∇_{α}²

F_{α}(x,y)=δ(x,y)−∇_{α}²(x,y)

The parameter αε[0, 1] controls the shape of the Laplacian operator. In practice, a 3×3 filter kernel is constructed with the center of the kernel being the origin (0, 0). An example of such a kernel is shown below:

$${F}_{1} ( x , y ) = [ \begin{matrix}- 0.5 & 0 & - 0.5 \\ 0 & 3.0 & 0 \\ - 0.5 & 0 & - 0.5\end{matrix} ]$$

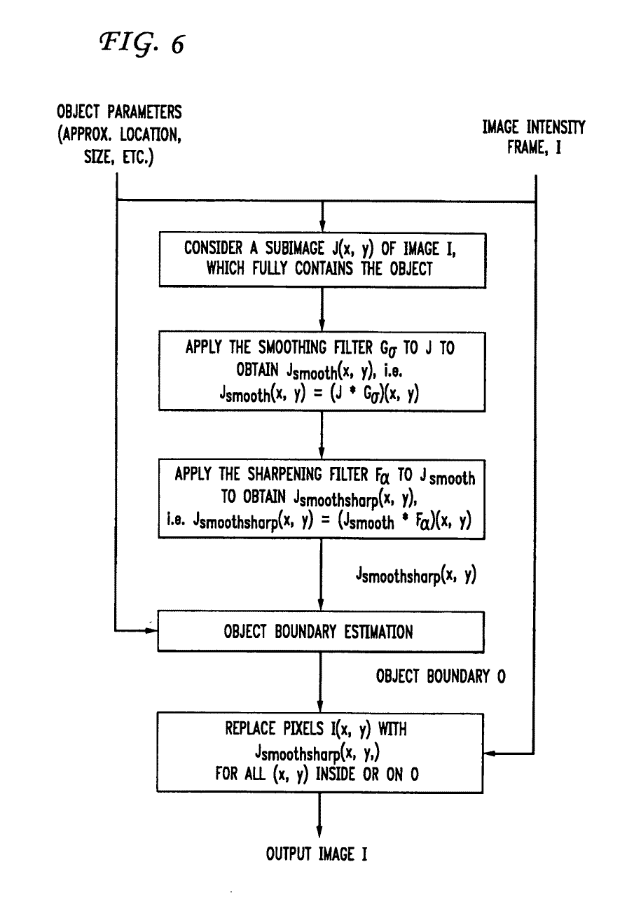

Object enhancement by enlargement attempts to extend the contour of an object by iteratively applying smoothing, sharpening and boundary estimation operations, not necessarily in that order. The flowchart for a specific embodiment of the object enlargement algorithm is shown in FIG. 6. The algorithm takes as its input the intensity image I(x, y), and the object parameters provided by object localization module 14. First, a region (subimage J) containing the object with a sufficient margin around the object, is isolated and smoothed using a Gaussian filter. This operation spreads the object boundary outward by a few pixels. Thereafter, a sharpening operation, described previously, is applied to make the edges clearer. Using the currently estimated object boundary, and the smoothed and sharpened subimage (Jₛₘₒₒₜₕₛₕₐᵣₚ), the boundary estimation algorithm is applied to obtain a new estimate of the object boundary, O. Finally, all the pixels in image I contained by O are replaced by the corresponding pixels in subimage Jₛₘₒₒₜₕₛₕₐᵣₚ.

The smoothing filter G_{σ} is a two-dimensional Gaussian function

$${G}_{σ} ( x , y ) = \frac{1}{2 {πσ}^{2}} exp ( - \frac{{x}^{2} + {y}^{2}}{2 {σ}^{2}} ) .$$

The parameter σ>0 controls the shape of the Gaussian function, greater values resulting in more smoothing. In practice, a 3×3 filter kernel is constructed with the center of the kernel being the origin (0, 0). An example of such a kernel is shown below:

$${G}_{1} ( x , y ) = [ \begin{matrix}0.0751 & 0.1238 & 0.0751 \\ 0.1238 & 0.2042 & 0.1238 \\ 0.0751 & 0.1238 & 0.0751\end{matrix} ]$$

The FIG. 1 system also includes means for encoding the enhanced video output from object enhancement module 16. Such means, identified in FIG. 1 as an object-aware encoder module 18, can be a module of conventional construction and operation that compresses the enhanced video with minimal degradation to important objects, by giving special treatment to the region of interest that contains the object of interest by, for example, allocating more bits to the region of interest or perform mode decisions that will better preserve the object. In this way, object-aware encoder 18 exploits the enhanced visibility of the object to encode the object with high fidelity.

To optimize enhancement of the input video, object-aware encoder 18 receives the object localization information from object localization module 14, thereby better preserving the enhancement of the region in which the object is located and, consequently, the object. Whether the enhancement is preserved or not, the region in which the object is located is better preserved than without encoding by object-aware encoder 18. However, the enhancement also minimizes object degradation during compression. This optimized enhancement is accomplished by suitably managing encoding decisions and the allocation of resources, such as bits.

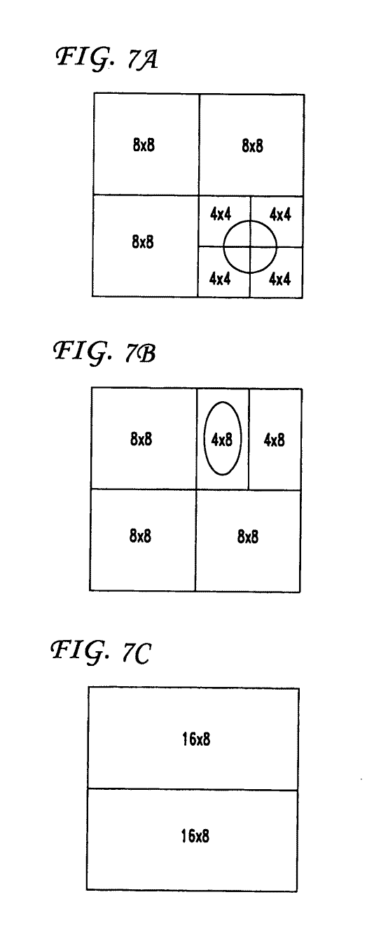

Object-aware encoder 18 can be arranged for making “object-friendly” macroblock (MB) mode decisions, namely those that are less likely to degrade the object. Such an arrangement, for example, can include an object-friendly partitioning of the MB for prediction purposes, such as illustrated by FIGS. 7A through 7C. Another approach is to force finer quantization, namely more bits, to MBs containing objects. This results in the object getting more bits. Yet another approach targets the object itself for additional bits. Still another approach uses a weighted distortion metrics during the rate-distortion optimization process, where pixels belonging to the regions of interest would have a higher weight than pixels outside the regions of interest.

Referring to FIGS. 7A through 7C, there are shown three possible sub-divisions of a 16×16 macroblock. Such sub-divisions are part of the mode decision that an encoder makes for determining how to encode the MB. One key metric is that if the object takes up a higher percentage of the area of the sub-division, then the object is less likely to be degraded during the encoding. This follows because degrading the object would degrade the quality of a higher portion of the sub-division. So, in FIG. 7C, the object makes up only a small portion of each 16×8 sub-division, and, accordingly, this is not considered a good sub-division. An object-aware encoder in various implementations knows where the object is located and factors this location information into its mode decision. Such an object-aware encoder favors sub-divisions that result in the object occupying a larger portion of the sub-division. Overall, the goal of object-aware encoder 18 is to help the object suffer as little degradation as possible during the encoding process.

As indicated in FIG. 1, object localization module 14, object enhancement module 16, and object-aware encoder module 18 are components of transmitter 20 that receives input video of a digital picture containing an object of interest and transmits a compressed video stream with the visibility of the object enhanced. The transmission of the compressed video stream is received by receiver 20, such as a cell phone or PDA.

Accordingly, the FIG. 1 system further includes means for decoding the enhanced video in the compressed video stream received by receiver 20. Such means, identified in FIG. 1 as a decoder module 22, can be a module of conventional construction and operation that decompresses the enhanced video with minimal degradation to important objects, by giving special treatment to the region of interest that contains the object of interest by, for example, allocating more bits to the region of interest or perform mode decisions that will better preserve the enhanced visibility of the object.

Ignoring temporarily the object-aware post-processing module 24, shown in dotted lines in FIG. 1, the decoded video output from decoder module 22 is conducted to a display component 26, such as the screen of a cell phone or a PDA, for viewing of the digital picture with enhanced visibility of the object.

The modes of operation of the FIG. 1 system that have been described above are characterized as pre-processing, in that the object is enhanced prior to the encoding operation by object enhancement module 16. The sequence is modified before being compressed.

Instead of enhancing the visibility of the object before encoding as described above, the input video can be conducted directly to object-aware encoder module 18, as represented by dotted line 19, and encoded without the visibility of the object enhanced and have the enhancement effected by an object-aware post-processing module 24 in receiver 20. This mode of operation of the FIG. 1 system is characterized as post-processing in that the visibility of the object is enhanced after the encoding and decoding stages and may be effected by utilizing side-information about the object, for example the location and size of the object, sent through the bitstream as metadata. The post-processing mode of operation has the disadvantage of increased receiver complexity. In the post-processing mode of operation, object-aware encoder 18 in transmitter 10 exploits only the object location information when the visibility of the object is enhanced in the receiver.

As indicated above, one advantage of a transmitter-end object highlighting system (i.e., the pre-processing mode of operation) is avoiding the need to increase the complexity of the receiver-end which is typically a low power device. In addition, the pre-processing mode of operation allows using standard video decoders, which facilitates the deployment of the system.

The implementations that are described may be implemented in, for example, a method or process, an apparatus, or a software program. Even if only discussed in the context of a single form of implementation (e.g., discussed only as a method), the implementation or features discussed may also be implemented in other forms (e.g., an apparatus or a program). An apparatus may be implemented in, for example, appropriate hardware, software, and firmware. The methods may be implemented in, for example, an apparatus such as, for example, a computer or other processing device. Additionally, the methods may be implemented by instructions being performed by a processing device or other apparatus, and such instructions may be stored on a computer readable medium such as, for example, a CD, or other computer readable storage device, or an integrated circuit.

As should be evident to one skilled in the art, implementations may also produce a signal formatted to carry information that may be, for example, stored or transmitted. The information may include, for example, instructions for performing a method, or data produced by one of the described implementations. For example, a signal may be formatted to carry as data various types of object information (i.e., location, shape), and/or to carry as data encoded image data.

Although the invention is illustrated and described herein with reference to specific embodiments, the invention is not intended to be limited to the details shown. Rather, various modifications may be made in the details within the scope and range of equivalents of the claims and without departing from the invention.

1. A system for enhancing the visibility of an object in a digital picture comprising:
means for providing an input video containing an object;
means for:
(a) storing information representative of the nature and characteristics of the object, and
(b) developing, in response to the input video and the information representative of the nature and characteristics of the object, object localization information that identifies and locates the object;
means, responsive to the video input and the object localization information, for developing an enhanced video of that portion of the input video that contains the object and the region of the digital picture in which the object is located; and
means for encoding the enhanced video.

2. A system for enhancing the visibility of an object in a digital picture according to claim 1 further including:
(a) means for transmitting the encoded enhanced video,
(b) means for decoding the encoded enhanced video, and
(c) means for displaying the enhanced video.

3. A system for enhancing the visibility of an object in a digital picture according to claim 1 wherein said means for developing the object localization information include
(a) means for scanning sectors of the input video, and
(b) means for comparing the scanned sectors of the input video with the stored information representative of the nature and characteristics of the object to identify and locate that object in the picture having the nature and characteristics similar to the stored information representative of the nature and characteristics of the object.

4. A system for enhancing the visibility of an object in a digital picture according to claim 3 wherein:
(a) the object localization information only approximates the identity and location of the object, and
(b) said means for encoding the enhanced input video:
(1) receive the object localization information, and
(2) include means for refining the object localization information.

5. A system for enhancing the visibility of an object in a digital picture according to claim 4 wherein said means for refining the object localization information include means for:
(a) estimating the boundary of the object, and
(b) enhancing the object.

6. A system for enhancing the visibility of an object in a digital picture according to claim 3 wherein:
(a) the object localization information only approximates the identity and location of the object, and
(b) said means for developing an enhanced video of that portion of the input video that contains the object and the region of the digital picture in which the object is located include means for refining the object localization information.

7. A system for enhancing the visibility of an object in a digital picture according to claim 6 wherein the means for refining the object localization information includes means for:
(a) estimating the boundary of the object, and
(b) enhancing the object.

8. A method for enhancing the visibility of an object in a digital picture comprising the steps of:
providing an input video of a digital picture containing an object;
storing information representative of the nature and characteristics of the object;
developing, in response to the input video and the stored information representative of the nature and characteristics of the object, object localization information that identifies and locates the object;
developing, in response to the input video and the object localization information, an enhanced video of that portion of the input video that contains the object and the region of the digital picture in which the object is located;
encoding the enhanced video; and
transmitting the encoded enhanced video.

9. A method for enhancing the visibility of an object in a digital picture according to claim 8 further including the steps of:
(a) receiving the encoded enhanced video,
(b) decoding the encoded enhanced video, and
(c) displaying the enhanced video.

10. A method for enhancing the visibility of an object in a digital picture according to claim 8 wherein said step of developing the object localization information includes the steps of:
(a) scanning sectors of the input video, and
(b) comparing the scanned sectors of the input video with the stored information representative of the nature and characteristics of the object to identify and locate that object in the picture having the nature and characteristics similar to the stored information representative of the nature and characteristics of the object.

11. A method for enhancing the visibility of an object in a digital picture according to claim 10 wherein:
(a) the object localization information only approximates the identity and location of the object, and
(b) said step of encoding the enhanced input video includes the steps of:
(1) receiving the object localization information, and
(2) refining the object localization information.

12. A method for enhancing the visibility of an object in a digital picture according to claim 11 wherein said step of refining the object localization information includes the steps of:
(a) estimating the boundary of the object, and
(b) enhancing the object.

13. A method for enhancing the visibility of an object in a digital picture according to claim 10 wherein:
(a) the object localization information only approximates the identity and location of the object, and
(b) said step of developing an enhanced video of that portion of the input video that contains the object and the region of the digital picture in which the object is located include the step of refining the object localization information.

14. A method for enhancing the visibility of an object in a digital picture according to claim 13 wherein said step of refining the object localization information includes the steps of:
(a) estimating the boundary of the object, and
(b) enhancing the object.

15. A system for enhancing the visibility of an object in a digital picture comprising:
means for providing an input video of a digital picture containing an object means for:
(a) storing information representative of the nature and characteristics of the object, and
(b) developing in response to the video input and the information representative of the nature and characteristics of the object, object localization information that identifies and locates an object; and
means, responsive to the video input and the object localization information, for encoding the input video.
